(19) United States
(12) Patent Application Publication
(10) Pub. No.: US 2025/0026570 A1
(43) Pub. Date: Jan. 23, 2025

(54) METHOD AND ORDER-PICKING APPARATUS FOR ASSEMBLING CONSUMABLE MATERIALS IN THE FORM OF PORTIONS AND PACKAGES

(71) Applicant: BECTON DICKINSON ROWA GERMANY GMBH, Kelberg (DE)

(72) Inventor: Christoph HELLENBRAND, Kaifenheim (DE)

(21) Appl. No.: 18/713,927

(22) PCT Filed: Oct. 28, 2022
(86) PCT No.: PCT/EP2022/080235

§ 371 Date: May 28, 2024

(30) Foreign Application Priority Data
Dec. 2, 2021 (EP) 21211960.6

(51) Int. Cl. B65G 1/137; B65G 47/90

(52) U.S. Cl. CPC B65G 1/1373; B65G 47/90; B65G 2203/041

(57) ABSTRACT

The present invention relates to a method and to an order-picking apparatus for assembling consumable materials in the form of portions and packages on the basis of assembly orders in a target container. Known methods and order-picking apparatuses cannot be used for order-picking assembly orders comprising portions and packages. According to the invention, a) an assembly order is analyzed, and b) a package is picked up at a storage location and fed to a target container. In a step c1), a storage container is picked up using the operating device and fed to a provision location, where a defined quantity of portions is removed from the storage container using a gripper. The gripper is then moved to the target container, and a portion is fed to the target container. The storage container is then fed back to a storage location by means of the control unit.

The present invention relates to a method and to an order-picking apparatus for assembling consumable materials in the form of portions and packages on the basis of assembly orders in a target container.

In modern order-picking apparatuses known from the prior art, a large number of different types of small piece goods are stored chaotically and in a space-optimized manner on elongated horizontal storage surfaces. These storage surfaces are provided by a plurality of shelves, wherein a plurality of small piece goods are stored per shelf, each at a storage location. In the case of chaotic, space-optimized storage, small piece goods, for example drug packages, food supplement packages, and other consumable materials in preferably cuboidal packages (bandages, etc.) are stored, in order-picking apparatuses that are used in pharmacies or hospitals, on the storage surfaces in such a way that the largest possible number of small piece goods can be stored per surface unit area of a storage surface. In chaotic storage, a storage location on the storage area or a shelf is not a permanently defined segment of this storage area with fixed dimension; rather, a storage location is defined by the package stored on the surface segment. Furthermore, the dimensions of a free surface segment primarily determine which package(s) are stored there.

With the aforementioned order-picking apparatuses, only cuboidal packages are regularly stored in the storage locations, or portions arranged in cuboidal carriers. Deviations from the cuboidal shape can only be stored with the known order-picking apparatuses if they have a flat base and parallel vertical sides.

However, it is not possible to store non-cuboidal portions, for example in the form of small bottles or syringes, in these order-picking apparatuses and to prepare them for assembly in combination with “normal” packages.

In hospitals, it is common practice to provide all the consumable materials required by, e.g., a ward, either in package form or in non-package form (referred to here as portions), collected as an assembly. At the ward, the packages and portions contained in the assembly are then processed individually for each patient. Since packages and portions are regularly required, it is not possible to pick assemblies for a ward fully automatically with the order-picking apparatuses described above, at least in the usual case in which this assembly comprises portions and packages.

It is the object of the present invention to provide a method and an order-picking apparatus with which consumable materials in the form of packages and portions can be assembled in a target container on the basis of assembly orders. The consumable materials may comprise drug packages and drug portions and other materials required in the form of portions and packages in hospitals, such as packaged bandaging material, food supplements, and the like.

The object is achieved by a method according to claim 1. In the method according to the invention for assembling consumable materials in the form of portions and packages on the basis of assembly orders in a target container, in a step a) an assembly order (AO) is analyzed and the type and quantity as well as storage locations of the packages and portions in a storage unit of an order-picking apparatus are determined.

In a step b), at a storage location assigned to a package, the package is picked up by an operating device and fed to a target container at an order-picking location of an order-picking unit of the order-picking apparatus. The order-picking location is a deposit location for the target container, wherein packages and portions are fed to the target container at this location.

In a step c1), at a storage location assigned to a portion a storage container is picked up by the operating device and fed to a provision location of the order-picking unit. The provision location is a deposit location for a storage container for portions (which cannot be stored and handled independently) at which a quantity of portions defined by the assembly order is removed from the storage container.

In a step c2), a gripper of a gripping device is then used to pick up a portion in the storage container at the provision location, and in a step c3) the gripper is moved to the target container and the portion is fed to the target container.

In a step c4), the storage container at the provision location is fed to a storage location by means of the operating device, wherein this storage location may be the storage location at which the storage container was previously located or a newly assigned storage location.

The sequence of the steps or step combinations b) and [c1), {c2)+c3)}, c4)] is arbitrary and the number of repetitions of the steps or step combinations depends on the assembly order, wherein the term “step combinations” means the steps [c1)-c4)] and {c2+c3)}, wherein the steps c2)+c3) can be executed as often as desired in the step combination c1)-c4) and the step combination c1)-c4) can be executed as often as desired (in each case depending on the assembly order), possibly “interrupted” by an execution of step b).

In an exemplary assembly order comprising two different packages and three portions of the same type, it is conceivable, for example, that a storage container with the matching portions is first fed to a provision location (step c1), three portions are then fed to the target container using the gripper (steps c2) and c3)) and, after the storage container has been fed to the provision location, the packages are fed to the target container using the operating device (step b)), wherein the feeding of the packages as well as the portions can be carried out in parallel, at least in sections, as different handling devices are used for these working steps. However, the aforementioned sequence of processing is not mandatory; it can also deviate depending, for example, on the positioning of the operating device relative to the requested packages and portions. Furthermore, the sequence can also deviate if, for example, the storage of a package or portion has not yet been completed at the time of the initial processing of the assembly order. With regard to the sequence of processing, the method according to the invention is therefore very flexible and is not tied to a specific sequence (with regard to packages and portions).

According to the invention, it is provided that packages and storage containers for portions are stored at storage locations in the order-picking apparatus. According to the invention, in step c2) a portion is picked up with the gripper of the gripping device. In one embodiment of the method according to the invention, it is provided that the portion in the storage container is picked up by moving the gripper to a specified position, this position being assigned a portion in the storage container. In this embodiment of the method, the portions are therefore arranged in the storage containers at known fixedly specified positions, wherein these positions within the storage container are known and, due to the known arrangement of the storage container at the provision location, the positions of the individual portions are known and can therefore be approached directly.

However, it is also conceivable that the portions are arranged in the storage container without a specified position, for example simply as “bulk material,” which on the one hand simplifies the arrangement of the portions in the storage container and on the other hand increases the storage capacity of a storage container for one type of portion. In such a case, it is provided according to the invention that a portion is picked up from a storage container by using a camera to create an image of the portions arranged in unordered fashion in the storage container, using image processing software to determine the exact arrangement of at least some of the portions and, based on this, determining a portion to be picked up and picking it up with the gripper. The use of image processing software to determine the exact arrangement of portions is known from the prior art and is disclosed in more detail, for example, in EP 3 854 730 A1, the content of which is hereby incorporated into this application. The gripper may for example be a suction gripper, which is also disclosed in the aforementioned application.

Depending on the size of an assembly order, it is possible that not all the packages and portions required for the assembly order are available at a given time X1. Further, it is conceivable that multiple assembly orders which are available at different times are to be assembled in a target container. In order to be able to at least partially process an assembly order in the first-mentioned case and, in the second-mentioned case, to enable multiple assembly orders to be brought together in a target container, it is provided in a preferred embodiment of the method according to the invention that after an assembly order or part of an assembly order has been processed, the target container is moved to a storage location with the aid of the operating device and the target container is stored.

In order to avoid delaying the processing of the next assembly order, for which a “new” target container is required at the order-picking location, after all the packages and portions have been assembled in the target container, a preferred embodiment of the method provides for the target container to be moved to a dispensing location after all the portions have been assembled, from which location the target container can be removed by an operator, for example.

The “new” target containers can be fed to the order-picking location by an operator, for example. In a preferred embodiment of the method, in which manual equipping of the order-picking location is avoided and thus fully automatic processing of a plurality of assembly orders is possible, it is provided that a target container is picked up from a storage location with the operating device and fed to the order-picking location. In this embodiment of the method according to the invention, the empty target containers are therefore stored in the storage unit of the order-picking apparatus.

The storage containers can be fed to the order-picking apparatus by an operator, for example. In a preferred embodiment, however, it is provided that the storage containers are provided for storage by means of a storage device and are moved from the storage device to a storage location by the operating device.

In order to document an assembly order and to increase reliability with regard to the assembly of the packages and portions, a preferred embodiment provides for the creation and storage of an image of the empty and/or completely filled target container before the first and/or last portion or package is fed in. By recording the empty target container, it can be documented that the container was in fact empty at the start of the assembly and that it did not contain a package or portion that did not correspond to the assembly order. Depending on the quantity of packages and portions, the image of the filled target container can be used to verify and document the correct execution of the assembly order.

In a further embodiment, it can also be provided that an image of the target container is created and stored after each portion and each package has been fed.

In a further embodiment, it is furthermore (additionally) provided that before or after the feeding of each portion and each package, a code of the portion or package is detected and compared with a target code. If the comparison shows that an incorrect package or incorrect portion has been moved into the target container, the process can be stopped. If the code is “correct,” it can be stored, for example, so that at the end of the assembly process it can be demonstrated without doubt that each package and/or portion of an assembly was moved into the target container in accordance with the assembly order. The code can be a bar code, a code from an RFID transponder or a DataMatrix code, for example.

A detection before the actual “feeding,” i.e., the depositing of a portion in a target container, can be carried out while the portion is picked up with the gripping device.

The above-named object is further achieved by an order-picking apparatus according to claim 10. The order-picking apparatus according to the invention for assembling portions and packages on the basis of assembly orders in a target container comprises a storage unit with at least one row of shelves with a plurality of horizontal shelves, each with a plurality of storage locations for packages and storage containers for a plurality of portions, at least one operating device which can be moved horizontally and vertically in front of the row of shelves and has a deposit surface for packages and storage containers and a transport device for moving packages and storage containers, at least one storing device with which packages and storage containers are moved into the storage unit and from which the operating device can remove packages and storage containers, and an identification device for identifying packages and storage containers.

Furthermore, the order-picking apparatus according to the invention comprises at least one order-picking unit with a provision station with a provision location for storage containers, the provision station being designed such that storage containers can be moved from the deposit area of the operating device to the provision location and from the provision location to the deposit area of the operating device, an order-picking station with an order-picking location for a target container, wherein the order-picking station is designed in such a way that packages can be moved by the operating device into the target container at the order-picking location, and with a gripping device arranged above the provision location and the order-picking location with a vertically and horizontally movable gripper or robot, with which portions can be conveyed from the storage container at the provision location into the target container.

In the device according to the invention, two types of “piece goods” are stored in a target container for the assembly of packages and portions, namely “normal” packages on the one hand and storage containers in which a plurality of portions are arranged on the other hand. The packages and the storage containers have in common that they are regularly cuboidal in shape and can be picked up and transported with the same operating device. In addition to the storage unit, which can essentially be realized for example by a device described above and known from the prior art, the order-picking apparatus according to the invention comprises at least one order-picking unit with which portions are fed to the target containers. This order-picking unit comprises a provision station and an order-picking station which are specially designed, wherein the provision station is designed so that storage containers can be moved from the deposit area to the provision location and from the provision location to the support area and the order-picking station is designed so that packages can be moved by the operating device into the target container. Due to this special way of designing the provision station and the order-picking station, it is conceivable for the at least one order-picking unit to be integrated into the storage unit or arranged outside the storage unit. Furthermore, it is conceivable for a storage unit to be combined with an internal order-picking unit and at least one or more external order-picking unit(s) to form an order-picking apparatus according to the invention.

By combining a storage unit with an order-picking unit and storing storage containers with portions in the storage unit, it is possible to provide an order-picking apparatus with which both packages as well as portions can be assembled in a target container.

As already indicated above, the portions can either be arranged in a defined location within a storage container or in unordered fashion (as bulk material, so to speak) in a storage container. In order to enable a portion to be picked up when it is arranged in an unordered manner in a storage container, it is provided in a preferred embodiment of the order-picking apparatus according to the invention that the order-picking unit comprises at least one camera, with which images of the contents of the storage container at the provision location can be created. In order to also be able to create an image of the contents of the target container at any desired time, it is also provided that the camera is arranged or is movable in such a way that the camera can also be used to take images of the contents of the target container at the order-picking location.

In one embodiment of the order-picking apparatus, in which the order-picking unit is arranged in the storage unit, the provision location for a storage container is regularly provided by one of the horizontal shelves. In such a case, the storage container can simply be placed directly on the shelf or provision location with the operating device. Alternatively, the provision location can also be provided by a section of a conveyor belt or a roller conveyor within the order-picking apparatus. However, in the case in which the order-picking unit is arranged outside the storage unit, it is provided that the order-picking unit comprises a storage container feed and return device with which storage containers can be moved from the access area of the operating device to the provision station and from the provision station to the access area of the operating device. For this purpose, the storage containers are placed on the storage container feed and return device with the operating unit and are moved from there to the provision station. The storage container feed and return device can be designed as a simple conveyor belt, for example.

In the simplest case of the external arrangement of the order-picking unit, the provision station is designed for only one storage container and comprises only one provision location for this storage container. The storage container is then fed directly to the provision location by means of the storage container feed and return device and is returned from there (to the access area of the operating device). However, this makes it necessary for a storage container to be returned to a storage location immediately after processing, because otherwise no further storage container can be processed.

In the case of an order-picking unit arranged outside the storage unit, it is provided in a preferred embodiment of the order-picking apparatus according to the invention that the provision station comprises a storage container transport device with which storage containers are fed to the provision location and which is designed such that at least one waiting location for storage containers is provided. Since in such a case the feed and return take place at different locations, it is further provided that the storage container feed and return device comprises a feed means and a return means.

In such a case, the order-picking unit therefore comprises at least one waiting location and one provision location, so that two storage containers with portions can be fed to the order-picking unit. The storage containers with portions are first fed to the waiting location, from where the storage containers are then moved to the provision location.

With the external arrangement of an order-picking unit, it can be advantageous for the above-mentioned reasons to feed the target container back to the storage unit after assembling part of an assembly order or a complete assembly order, in order to complete the assembly order later or to feed a further assembly order to the target container. To make this possible, it is provided in a preferred embodiment that the order-picking unit comprises a target container return device with which a target container can be moved from the order-picking location into the access area of the operating device. The target container is then picked up by the operating device and fed to a storage location.

In the case of the external arrangement of the order-picking unit, it is further provided that the order-picking unit comprises a package feed device with which packages can be moved from the grip area of the operating device into the target container. Such a feed device can for example be designed as a simple chute to which the operating device can feed packages and which ends above the target container at the order-picking location.

In the following, preferred embodiments of the order-picking apparatus according to the invention and a preferred embodiment of the method according to the invention are described with reference to the drawing, in which:

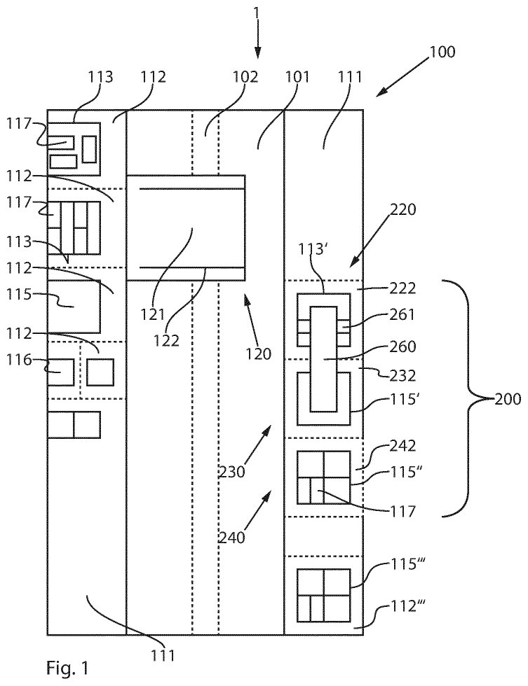

FIG. 1 shows a schematic plan view of a first embodiment of the order-picking apparatus according to the invention,

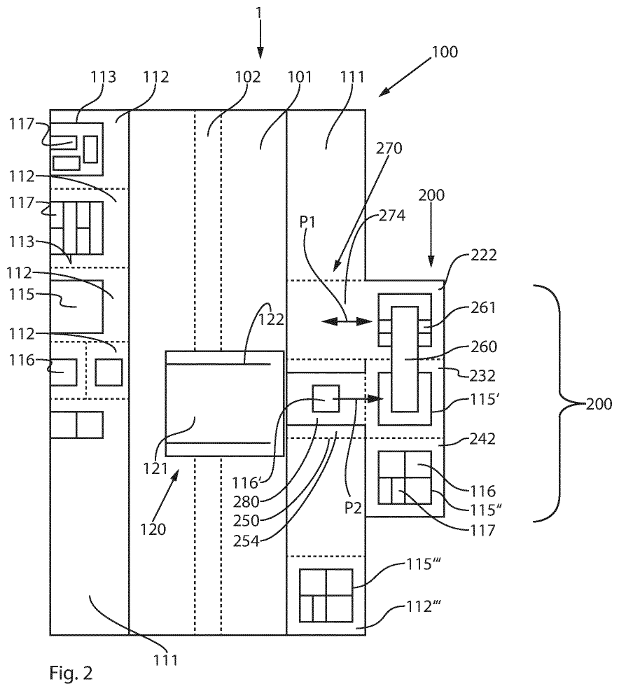

FIG. 2 shows a schematic view of a second embodiment of the order-picking apparatus according to the invention,

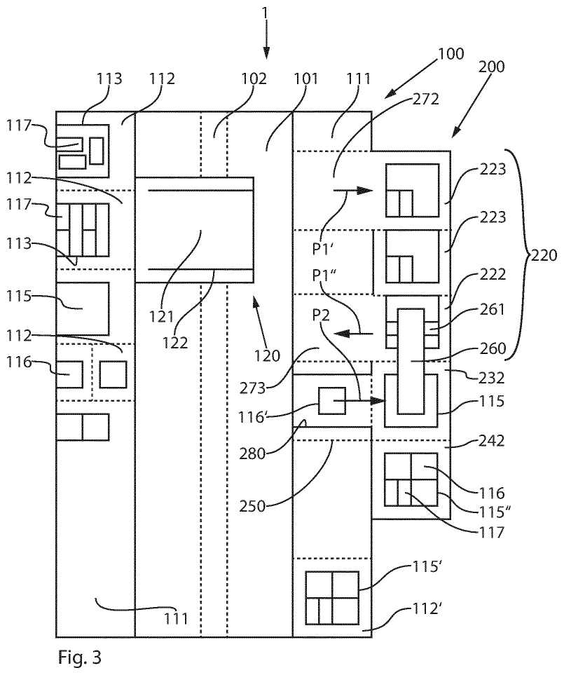

FIG. 3 shows a schematic plan view of a third embodiment of the order-picking apparatus according to the invention,

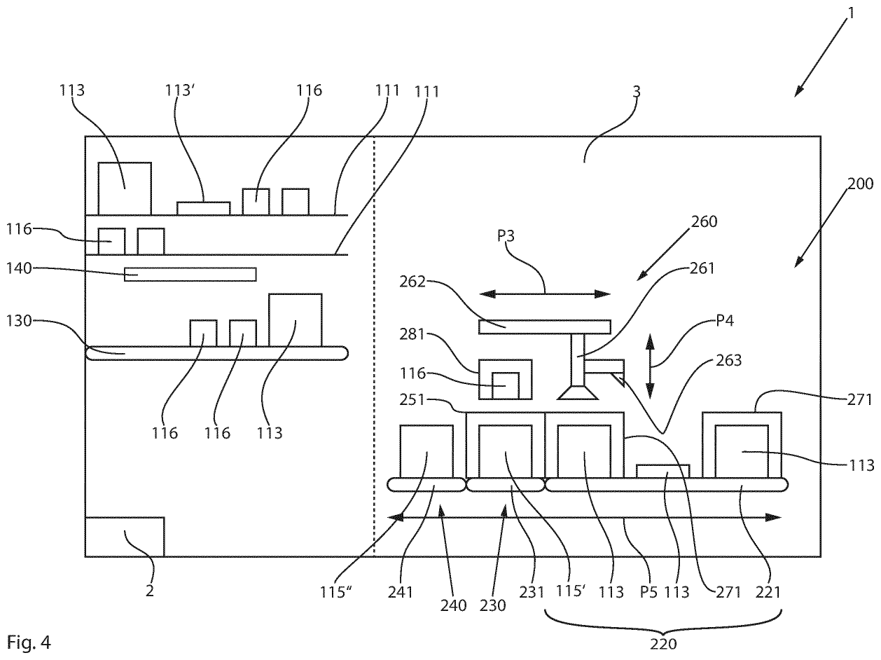

FIG. 4 shows a schematic side view of the third embodiment, and

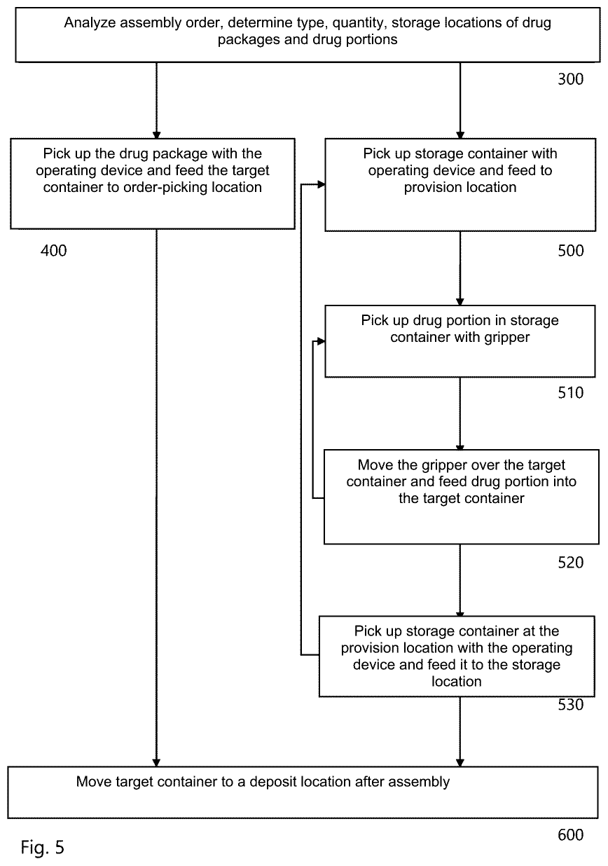

FIG. 5 shows a flow chart of a preferred embodiment of the method according to the invention.

FIG. 1 shows a first embodiment of an order-picking apparatus 1 according to the invention with a storage unit 100 with two parallel rows of shelves, each with a plurality of horizontal shelves 111, each having a plurality of storage locations 112 for drug packages 116 and storage containers 113. An aisle 101 is arranged between the two rows of shelves, in which an operating device 120 can be moved vertically and horizontally on a horizontal guide 102, wherein the vertical guide for the operating device 120 is omitted in the schematic representation shown in FIG. 1.

As can be seen in the left-hand row of shelves, two storage containers 113, a target container 115, and a plurality of packages 116 are arranged on the upper shelf 111, each at a storage location 112, the storage locations as such being based on the containers resting on a shelf or the packages and storage containers being deposited on a shelf 111 at an area whose dimensions are sufficient to accommodate them. The arrangement, number, and size of the storage locations per shelf is therefore not fixed, but varies with the type of containers stored, i.e., packages or storage containers.

As is indicated for the two storage containers 113, portions 117 held in the storage containers can be arranged chaotically (the upper storage container 113) or in unordered fashion or in receptacles provided in the storage container (as indicated in the lower storage container), wherein the receptacles for the portions are omitted in the merely schematic representation according to FIG. 1.

The operating device 120, which can be moved horizontally and vertically in front of the rows of shelves, comprises a deposit table 121 for storage containers and packages and a gripping device 122, with which packages and storage containers can be moved from a storage location to the deposit table and from the deposit table to, e.g., a storage location. The operating device may for example be a jaw gripper as disclosed for example in patent application EP 3 431 421 A1, the disclosure of which is hereby incorporated into the present application in order to avoid a detailed description of the operating device 120.

Although this is not explicitly shown, the operating device 120 can also be rotated about the vertical axis in the illustrated embodiment. In an alternative embodiment, the operating device can be designed to be so wide that packages and storage containers can be moved onto the deposit table via one end facing a row of shelves, and from the deposit table to e.g., a storage location via the other end.

In addition to the storage unit 100, the order-picking apparatus 1 according to the invention comprises an order-picking unit 200 which is integrated into the storage unit 100 in the embodiment shown, for which purpose it may be necessary to omit a shelf in the region of the order-picking unit, depending on the exact arrangement of the shelves. In the embodiment shown, the order-picking unit 200 is arranged in the “right” half of the storage unit 100, with the depth of the order-picking unit 200 corresponding to the depth of the shelves 111. As a result, certain elements of the order-picking unit 200 can be realized by segments of a shelf, as described in more detail below.

In the embodiment shown in FIG. 1, the order-picking unit 200 comprises a provision station 220 with a provision location 222, which in the embodiment shown is realized as a section of a shelf 111. A storage container 113′ with a plurality of portions (not shown) is arranged at the provision location 222. An order-picking station 230 with an order-picking location 232 is arranged next to the provision station 220, wherein in the embodiment shown the order-picking location 232 is also realized as part of or on a section of a shelf 111. A target container 115′ is arranged at the order-picking location 232, in which container packages and portions can be assembled.

In order to transfer portions from the storage container 113′ to the target container 115′, a gripping device 260 is arranged above the provision location and the order-picking location, which gripping device comprises a horizontally and vertically movable gripper 261 with which portions can be removed from the storage container 113′ and transferred to the target container 115′. The gripper may for example be a suction gripper as disclosed in patent application EP 3 854 730 A1, the content of which is hereby incorporated into this application in order to avoid a detailed description of the gripper 261.

In the embodiment shown, the order-picking unit 200 further comprises a dispensing station 240 with a dispensing location 242 at which a target container 115″ is arranged, in which multiple portions 117 and multiple packages 116 are arranged. The target container 115″ can be removed from the dispensing location 242 by, e.g., an operator, as indicated by the dashed region of the outer wall of the storage unit 100.

A target container 115″′ at a storage location 112″′ is also indicated in the lower region of the right-hand row of shelves. The target container 115″′ was moved from the order-picking location to the storage location 112″′ using the operating device 120, for example in order to pick further packages and/or portions into the target container 115″′ at a later time.

FIG. 2 shows a second embodiment of the order-picking apparatus 1 according to the invention. In this embodiment, the order-picking unit 200 is arranged “outside” the storage unit. Due to the outside arrangement of the order-picking unit 200, the operating device 120 can no longer move the storage containers (and possibly the target containers) directly to the corresponding locations of the provision station 220 and the order-picking station 230, since these are arranged outside the access area of the operating device 120.

In this embodiment, the order-picking unit 200 therefore comprises a storage container feed and return device 270 with which storage containers can be moved from an access area 274 of the operating device to the provision location 222 of the provision station 220 and from the provision location into the access area 274 of the operating device, as indicated by the arrow P1. In the embodiment shown, this storage container feed and return device 270 may for example be a simple conveyor belt; the provision location 222 is then realized or formed by a section of the storage container feed and return device 270.

In the embodiment shown, the order-picking apparatus further comprises a target container return device 250 with which a target container 115′ can be moved from the order-picking location 232 into an access area 254 of the operating device. In alternative embodiments (in which no storing or intermediate storage of a target container 115′ is necessary), the target container return device 250 can be omitted, and the completely filled target container 115′ can be removed by, e.g., an operator.

In the embodiment shown, the order-picking unit 200 further comprises a package feed device 280 with which a package 116′ can be moved from the operating device into the target container 115′, as indicated by the arrow P2. In the simplest case, the package feed device 280 can be a chute that ends above the target container 115′.

FIG. 3 shows a third preferred embodiment in which the order-picking unit 200 is also shown outside the storage unit 100. In the following, only the differences from the second embodiment are described, in order to avoid repetition. In this embodiment, the provision station 220 comprises a storage container transport device 221 (see also FIG. 4), with which storage containers are fed to the provision location 222 and which is designed such that at least one waiting location 223 for storage containers is provided. The storage container transport device thus offers the option of keeping multiple storage containers ready for processing in the order-picking unit without having to interrupt the processing of the packages of the current assembly order. In alternative embodiments, multiple waiting locations 223 may also be provided. The storage container transport device 221 can for example be designed as a conveyor belt which interacts with the storage container feed and return device 270 for picking up and forwarding storage containers.

The provision of at least one waiting location 223 requires that the feed and return of storage containers have to take place at separate locations, since a storage container at the waiting location at least potentially prevents a return transport of the target container with the storage container transport device. Therefore, in this embodiment the storage container feed and return device 270 comprises a feed means and a return means 272, 273. The feed means 272 is used to feed storage containers from the access area of the operating device to the provision station (namely to a section of the storage container transport device 221 of the provision station) (see arrow P1′), and the return means 273 is used to move storage containers into the access area of the operating device after portions have been removed (see arrow P1″).

FIG. 4 shows a schematic side view of the embodiment shown in FIG. 3, with part of the housing 3 of the storage unit being omitted in the left-hand section of the storage unit 100. In this left-hand section, under two shelves 111 a storing device 130 can be seen for moving packages 116 and storage containers 113 into the storage unit 100 and the access area of the operating device 120, which device removes the storage containers and packages from the conveyor device, which can be designed, e.g., as a conveyor belt, and moves them to a storage location. An identification device 140 for identifying packages 116 and possibly storage containers 113 is arranged above the storing device 130. A control device 2 is also indicated at the base of the storage unit 100, to which the components of the storage unit and the order-picking unit to be controlled are coupled. The control unit can also be used to analyze an assembly order and to determine storage locations.

In the embodiment according to FIG. 4, a camera 263 is arranged at the gripper 261 of the gripping device 260, with which images of the target container can be created, which are subsequently stored, e.g., in the control unit and evaluated if necessary (for example in order to determine a portion to be picked up and its exact position).

FIG. 4 also shows that the housing 3 of the order-picking apparatus comprises two openings 271 for the feed and return means of the storage container feed and return device and an opening 251 for the target container return device. An opening 281 for the package feed device is also provided in the housing above the target container 115′.

FIG. 4 also shows the storage container transport device 221, with which storage containers are fed to the provision location 222 and which in this embodiment comprises a waiting location for storage containers. In addition to the provision station 220 with the storage container transport device 221, the order-picking station 230 and the dispensing station 240 can also be seen; depending on the precise configuration of the order-picking unit 200, these can also comprise transport devices 231 and 241 in order to actively move target containers from the order-picking location to the dispensing location.

FIG. 5 describes a preferred embodiment of the method according to the invention, with reference to the embodiment according to FIG. 1, i.e., with “internal” order-picking unit 200. In a step 300, the control device 2 first receives and analyzes an assembly order AO and determines the type and quantity as well as storage locations 112 of the packages 116 and portions 117 in the storage unit 100 of the order-picking unit 1. Usually, a storage container 113 assigned to a portion of the assembly order is first picked up with the operating device according to step 500 and fed to the provision location 222, i.e., in this case placed thereon with the operating device. The operating device can then be used to carry out step 400 as often as necessary, namely to pick up a package of the assembly order and feed it to the target container. Parallel to this, in a step 510, a portion 117 in the storage container is picked up with the gripper 261, and in a step 520 the gripper is moved over the target container (which was previously moved to the order-picking location by a user or with the operating device) and the portion is deposited or dropped into the target container. Depending on the number of portions of the “current” type (i.e., arranged at the provision location), the two aforementioned steps are repeated as often as necessary (as indicated by the arrow between 520 and 510). When all portions have been transferred, in a step 530 the storage container at the provision location is picked up by the operating device (the provision location is in the access area of the operating device) and fed to a storage location. The aforementioned steps 500-530 are repeated until all portions have been deposited in the target container 115′. Subsequently, in a step 600 the target container 115′ is moved to the dispensing location 242, using the operating device. Alternatively, this can also be done with a conveyor device such as a conveyor belt.

1. A method for assembling consumable materials in the form of portions and packages on the basis of assembly orders in a target container, wherein
a) an assembly order is analyzed and the type and quantity, as well as storage locations of the packages and portions in a storage unit of an order-picking apparatus are determined,
b) at a storage location assigned to a package, the package is picked up by an operating device and fed to a target container at an order-picking location of an order-picking unit of the order-picking apparatus,
c1) at a storage location assigned to a portion, a storage container is picked up by the operating device and fed to a provision location of the order-picking unit,
c2) a portion in the storage container at the provision location is gripped with a gripper of a gripping device,
c3) the gripper is moved to the target container and the portion is fed to the target container, and
c4) the storage container at the provision location is fed to a storage location by the operating device,
wherein the sequence of steps or step combinations b) and [c1), {c2)+c3)}, c4)] is arbitrary and the number of repetitions depends on the assembly order.

2. The method of claim 1,
wherein a portion is picked up by moving the gripper to a specified position, the position being assigned to a portion in the storage container.

3. The method of claim 1,
wherein a portion is picked up by using a camera to create an image of the portions arranged in unordered fashion in the storage container, using image processing software to determine the exact arrangement of at least some of the portions and, based on this, determining and picking up a portion to be picked up.

4. The method of claim 1,
wherein after the assembly order or a part thereof has been processed, the target container is moved to a storage location of the storage unit with aid of the operating device, and the target container is stored.

5. The method of claim 1,
wherein the target container is moved to a dispensing location after all the packages and portions have been assembled.

6. The method of claim 1,
wherein the target container is picked up by the operating device from a storage location and fed to the order-picking location.

7. The method of claim 1,
wherein the storage containers are provided for storage by a storing device and are moved to a storage location by the operating device.

8. The method of claim 1,
wherein an image of one of the empty and filled target container is created and stored before the feeding of one of the first and last portion or package.

9. The method of claim 8,
wherein after the feeding of each portion and each package, an image of the target container is created and stored.

10. The method of claim 1,
wherein before or after the feeding of each portion and each package, a code of the portion or package is detected and compared with a target code.

11. An order-picking apparatus for assembling consumable materials in the form of portions and packages on the basis of assembly orders in a target container, comprising
a storage unit having,
at least one row of shelves with a plurality of horizontal shelves, each with a plurality of storage locations for packages and storage containers for a plurality of portions,
at least one operating device, which can be moved horizontally and vertically in front of the row of shelves, with a deposit table and a transport device for moving packages and storage containers,
at least one storing device, with which packages and storage containers are moved into the storage unit and from which the operating device can remove packages and storage containers, and
an identification device for identifying packages and storage containers, and
at least one order-picking unit having
a provision station with a provision location for a storage container, wherein the provision station is designed in such a way that storage containers can be moved from the deposit table of the operating device to the provision location and from the provision location to the deposit table,
an order-picking station with an order-picking location for a target container, the order-picking station being designed in such a way that packages can be moved by the operating device into the target container at the order-picking location,
and a gripping device arranged above the provision location and the order-picking location with a vertically and horizontally movable gripper, with which portions can be conveyed from the storage container at the provision location into the target container.

12. The order-picking apparatus of claim 11,
wherein the order-picking unit comprises at least one camera, with which images can be produced of the contents of the storage container at the provision location and/or of the target container at the order-picking location.

13. The order-picking apparatus of claim 11,
wherein the order-picking unit comprises a storage container feed and return device, with which storage containers can be moved from an access area of the operating device to the provision station and from the provision station into the access area of the operating device.

14. The order-picking apparatus of claim 13,
wherein the provision station comprises a storage container transport device, with which storage containers are fed to the provision location and which is designed in such a way that at least one waiting location for storage containers is provided, and
in that the storage container feed and return device comprises a feed and return means.

15. The order-picking apparatus of claim 13,
wherein the order-picking unit comprises a target container return device with which a target container can be moved from the order-picking location into the access area of the operating device.

16. The order-picking apparatus of claim 13,
wherein the order-picking unit comprises a package feed device with which packages can be moved by the operating device into the target container.
